(19) United States
(12) Patent Application Publication
(10) Pub. No.: US 2014/0067531 A1
(43) Pub. Date: Mar. 6, 2014

(54) OFFER GENERATION BASED UPON USER ACTIVITY

(71) Applicant: Steel House, Inc., Los Angeles, CA (US)

(72) Inventors: Mark Douglas, Marina Del Rey, CA (US); Takuju Ueda, Rancho Palos Verdes, CA (US); Marwan Soghaier, Los Angeles, CA (US)

(73) Assignee: Steel House, Inc., Los Angeles, CA (US)

(21) Appl. No.: 13/947,766

(22) Filed: Jul. 22, 2013

Related U.S. Application Data
(60) Provisional application No. 61/696,691, filed on Sep. 4, 2012.

(51) Int. Cl. G06Q 30/02

(52) U.S. Cl. CPC G06Q 30/0255; G06Q 30/0253
USPC 705/14.53

(57) ABSTRACT

There is disclosed a method for offer generation based upon website activity. The method comprises accessing a user identification system to identify a user in response to interaction by the user with a first website accessible to an offer server and monitoring the activity of the user on the first website. Next, the method includes determining that the user provided intent indicia indicating that the user intended to carry out an action on the first website and storing the purchase intent indicia in a database. Finally, the method includes accessing the database in response to further interaction by the user with a second website serviced by the offer server in order to obtain the intent indicia and to provide intent-related content to the user in response to the purchase intent indicia.

### RELATED APPLICATION INFORMATION

This patent claims priority from Provisional Application No. 61/696,691, entitled OFFER GENERATION BASED UPON USER ACTIVITY, filed Sep. 4, 2012.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to offer generation based upon user activity.

2. Description of the Related Art

Online advertisement continues to grow as Internet users spend increasing time consuming web-based content. Click-throughs and conversions of advertisements are easy to associate with the advertisement. However, taking user activity on a web site into account in an effort to generate purchases or to be responsive to user activity has been difficult.

Current online advertising systems enable advertisers to determine when a user has visited various sites, but do not provide any real-time indication of or reaction to user activity on a given site. As a result, users considering purchases on a website are provided only a price and may choose to accept or reject the offer. No dynamic alteration of pricing, shipment fees, taxes or other offer variables are available to a potential customer. As such, potential opportunities to persuade a near-purchase user to complete a purchase may be lost.

### DESCRIPTION OF THE DRAWINGS

FIG. 1 is a diagram of an offer generation system.

FIG. 2 is a diagram of a computing device.

FIG. 3 is a diagram of a system for offer generation based upon user activity.

FIG. 4 is a flowchart of offer generation based upon user activity.

Throughout this description, elements appearing in figures are assigned three digit reference designators, where the most significant digit is the figure number where the element is introduced and the two least significant digits are specific to the element. An element that is not described in conjunction with a figure may be presumed to be the same as a previously-described element having the same reference designator.

### DETAILED DESCRIPTION

Description of Apparatus

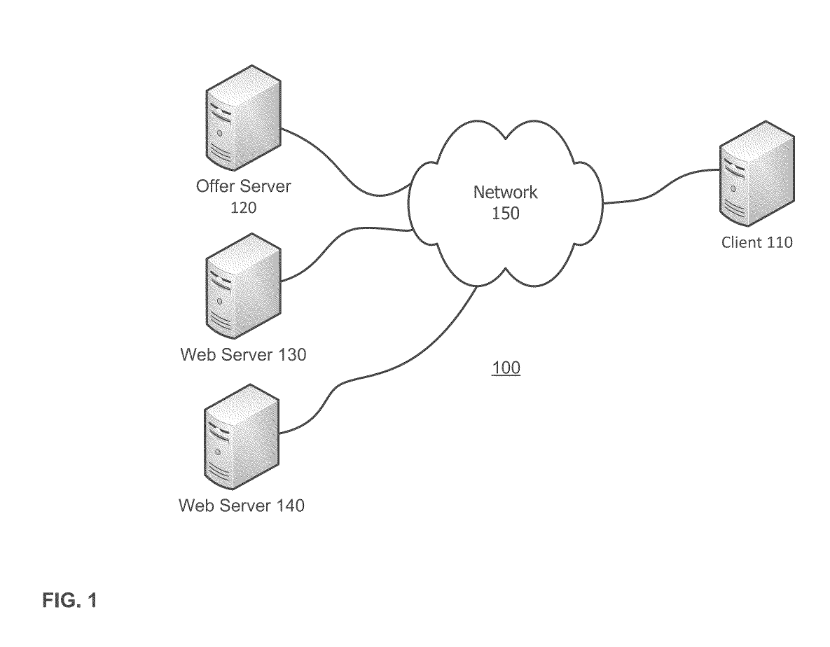

Referring now to FIG. 1, an offer generation system 100 is shown. The system 100 includes a client 110, an offer server 120, a web server 130 and a web server 140 interconnected via a network 150.

The client 110 is connected to the network. The client 110 is shown as a computer, but may take many forms. The client 110 may be a personal computer, lap-top computer, mobile device, a tablet PC, a personal digital assistant, a smartphone, a “dumb” phone, a feature phone, a server computer operating as a part of a distributed or peer-to-peer network or many other forms.

The offer server 120 provides offers to the client 110 upon receipt of offer requests. One offer server 120 is shown, but the offer server 120 may include one or more servers capable of providing offers in conjunction with one another. The offer server 120 may include one or more processors.

The web server 130 serves web pages to computing devices such as the client 110. The web server 130 may access or utilize the offer server 120 to provide offers to the client 110 when web pages are requested. The web server 140 operates in a manner similar to that of web server 130.

The network 150 may take the form of a local network, a wide area network, the Internet or any number of other networks. The network 150 may be implemented locally by physically connected computers or may be distributed over a wide area.

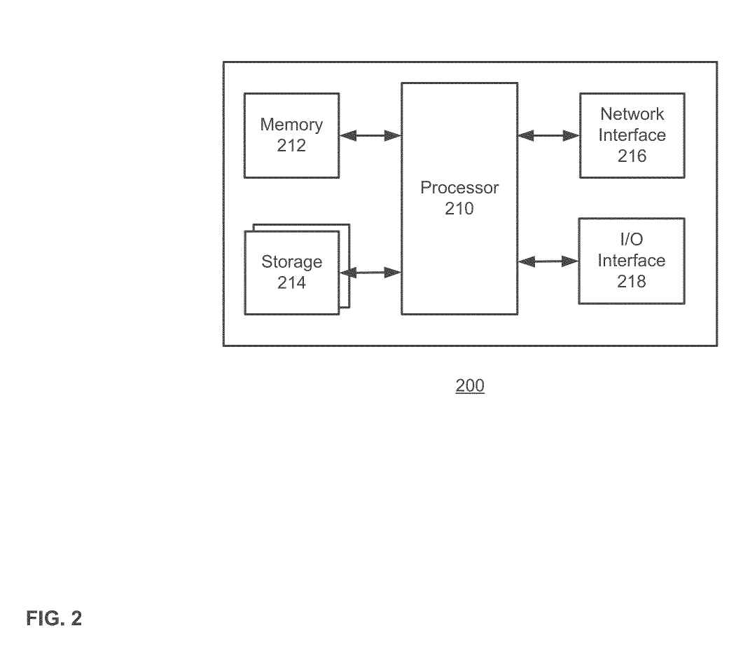

Turning now to FIG. 2, there is shown a computing device 200, which is representative of the server computers, client devices, mobile devices and other computing devices discussed herein. The computing device 200 may include software and/or hardware for providing functionality and features described herein. The computing device 200 may therefore include one or more of logic arrays, memories, analog circuits, digital circuits, software, firmware and processors. The hardware and firmware components of the computing device 200 may include various specialized units, circuits, software and interfaces for providing the functionality and features described herein.

The computing device 200 has a processor 210 coupled to a memory 212, storage 214, a network interface 216 and an I/O interface 218. The processor may be or include one or more microprocessors, application specific integrated circuits (ASICs), programmable logic devices (PLDs) and programmable logic arrays (PLAs).

The memory 212 may be or include RAM, ROM, DRAM, SRAM and MRAM, and may include firmware, such as static data or fixed instructions, BIOS, system functions, configuration data, and other routines used during the operation of the computing device 200 and processor 210. The memory 212 also provides a storage area for data and instructions associated with applications and data handled by the processor 210.

The storage 214 provides non-volatile, bulk or long term storage of data or instructions in the computing device 200. The storage 214 may take the form of a disk, tape, CD, DVD, or other reasonably high capacity addressable or serial storage medium. Multiple storage devices may be provided or available to the computing device 200. Some of these storage devices may be external to the computing device 200, such as network storage or cloud-based storage. In this patent, the term “storage medium” does not encompass transient media such as signals and waveforms that convey, but do not store information.

The network interface 216 includes an interface to a network such as network 150 (FIG. 1).

The I/O interface 218 interfaces the processor 210 to peripherals (not shown) such as displays, keyboards and USB devices.

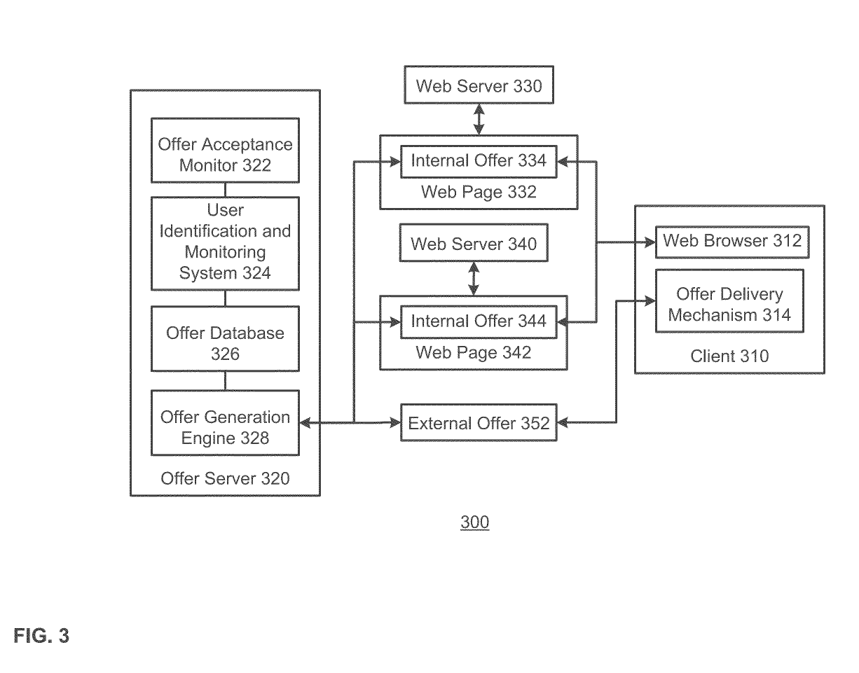

Turning now to FIG. 3, a diagram of a system 300 for offer generation based upon user activity is shown. The system 300 includes a client 310, an offer server 320, a web server 330 serving a web page 332, a web server 340 serving a web page 342 and an external offer 352. The client 310 includes a web browser 312 and an offer delivery mechanism 314. The offer server 320 includes an offer acceptance monitor 322, a user identification and monitoring system 324, an offer database 326 and an offer generation engine 328. The web pages 332 and 342 may incorporate internal offers 334 and 344.

The client 310 is representative of a user operating a computing device upon which offers may be made. The client 310 may be a personal computer, a mobile phone, a thin client, a television with web access or a similar device. The client 310 includes at least one of a web browser 312 or another offer delivery mechanism 314. The web browser 312 is a typical web browser capable of displaying hypertext markup language and other web-based content.

The offer delivery mechanism 314 may be software, hardware or a combination of both that is used to present email messages; SMS texts; dynamic in-email offers displayed when the email is viewed; in-application advertisements, for example, in smartphone applications; audio advertisements via the web, radio or streaming radio; and video advertisements embedded in web-based television, streaming video or purchased or rented video viewed on the client 310. The offer delivery mechanism 314 may be capable of relaying offers to users and providing information to the offer server on delivery of the offers to a particular user.

The offer server 320 is a server designed to provide offers. The offer server 320 may provide offers in response to requests to do so. An “offer” as used herein is one or more of an advertisement, promotion, discount, free shipping, free tax, free gift, survey request, a suggestion to purchase a related product, a suggestion to purchase a similar product, a link to a promoted product available to only a select few purchasers, a link to a different website or additional information related to a product or query. An “offer” is generated in response to current and past activity by the user. Furthermore, an “offer” as used herein is provided by the offer server 320 for use on a web page or in a mobile application without the operator of the web server or designer of the mobile application setting aside a specific location of the web page or mobile application designed to accommodate the offer. Instead, offers are overlays or otherwise use dynamically allocated space on or hovering over a web page. Specifically, an “offer” is not a textual or graphical element of a web page or mobile application that is placed into a predetermined location, set aside by the web page or mobile application designer to accommodate the textual or graphical element, regardless of whether that textual or graphical element is predetermined or selected at load-time of the web page.

For example, a request to an offer server 320 may be made using a tracking pixel in a web page. In response to that request, an offer may be a cascading style sheet, JavaScript applet, or portion of hypertext markup language that is served as a part of the web page or mobile application that generated the request. This offer, therefore, may be automatically integrated into or presented in conjunction with any web page or mobile application without altering the desired layout and without making changes to the underlying code that is rendered or executed to generate the web page or mobile application user interface.

The offer server 320 may simultaneously monitor and provide offers to multiple web pages. This may be referred to herein as “service” of or “serviced by” the offer server 320. The offer server 320 incorporates a number of elements. The first may be an offer acceptance monitor 322 that determines whether or not an offer made to a user has been accepted.

The offer server 320 also includes a user identification and monitoring system 324 for identifying a particular user and monitoring that user's activity on web sites serviced by the offer server 320. The user identification and monitoring system 324 may identify users based upon their IP addresses, MAC addresses, user login or any number of other methods, such as utilizing a tracking pixel embedded in a web page served by web servers 330 and 340. These tracking pixels may, for example, load a single pixel from the offer server 320 that enables the user identification and monitoring system 324 to identify the user that requested a web page served.

The user identification and monitoring system 324 may also include a database of user activity on web sites served by the offer server 320. This database may be used to track purchases by the users in addition to other information such as browsing activity related to particular products or services including non-purchase or near-purchase activity indicating an interest in a particular product or service or a particular type of product or service. These activities may be tracked and stored in the database as a given user visits multiple, distinct web sites serviced by the offer server 320.

The offer server 320 may also include an offer database 326 that stores the various offers and the rules associated with those offers. For example, the offer database 326 may include rules that cause the offer server 320 to provide an even more user-beneficial offer for a product after a user has failed to respond to a particular offer or to complete a purchase of the product after viewing the product. Alternatively, the offer database 326 may track a user's activities and present offers in response to particular user activities or interactions with the offer server 320 or web servers 330 or 340.

The offer server 320 may also include an offer generation engine 328 that utilizes the user identification and monitoring system 324 and the rules in the offer database 326 to generate offers in response to requests to do so. The offer generation engine 328 has access to a database of text offers, display offers, overlay offers, floating offers, side-panel offers or other types of offers that may be provided to a user. These offers may be hosted locally, for example, as a part of the offer database 326, may be hosted on the web servers 330 and 340 or may be hosted by a service designed to provide high availability to web content.

The web server 330 may be a typical web server or web servers capable of serving web content for viewing in a web browser 312. The web server 330 may also serve related content such as streaming audio, video, images and other associated media. The web server 330 may be implemented on a plurality of web servers or a distributed server farm offering high accessibility.

The web server 330 serves web pages like web page 332 which may include offers like internal offer 334. The web server 330 may or may not be a part of, or integrated with, the offer server 320. The web server 330 may be operated or maintained by an offeror, the entity making offers using the offer server 320. The web pages served by the web server 330 may include embedded links, images or other references to offers generated by the offer server 320.

Internal offer 334 is “internal” because it is integrated into web page 332 viewed by a web browser 312. The external offer 352 is “external” because it is separate and apart from a web page. The external offer 352 may take the form of an offer integrated into the offer delivery mechanism 314 described above.

The web server 340 may operate in a manner similar to web server 330. The offer server 320 may be capable of integrating user interaction with web servers 330 and 340 so as to generate a more complete database of user activity related to a product, service or group of products and services. For example, web server 330 and web server 340 may be operated by competing companies offering similar products. Through the use of the offer server 320 to service both web server 330 and web server 340, activity by a user identified by the user identification and monitoring system 324 may indicate that the user is, for example, viewing similar products on both web servers 330 and 340. As a result, when that same user returns to or continues to interact with one or more web pages associated with either of the competing products, a relevant offer related to either product may be provided to the user.

Description of Processes

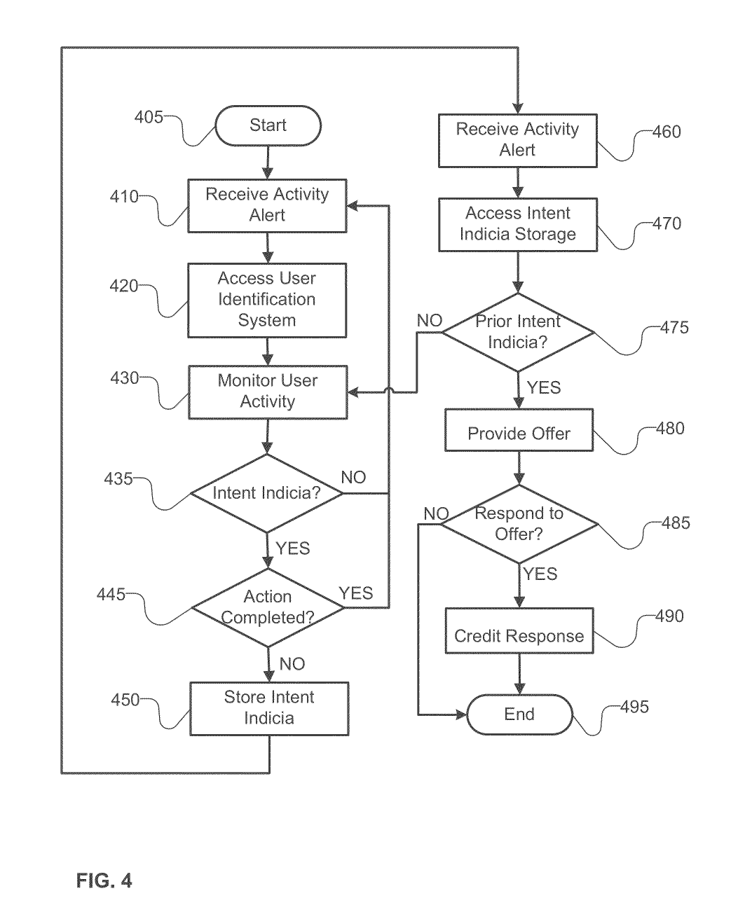

Turning now to FIG. 4, a flowchart of offer generation based upon user activity is shown. This process is completed by an offer server such as offer server 320. The flow chart has both a start 405 and an end 495, but the process may be cyclical in nature. Portions of the process may be accomplished in parallel or serially. Multiple instances of the process may take place simultaneously.

First, an activity alert is received at 410. The activity alert indicates that a user has requested or interacted with a web page (or mobile application) associated with a particular product, service or set of information. This activity alert may be a formal activity alert generated, for example, in response to a user request for a web page served by web server 330. Alternatively, the activity alert may be user activity on a web page served by web server 330.

The request for the web page may include an embedded tracking pixel that is served to the user by the offer server 320. The tracking pixel may provide information such as the IP address, MAC address or similar information to the offer server 320. At the same time or alternatively, the web server 330 and offer server 320 may communicate with one another to share information such as user logins, accounts, prior activity or prior purchase history. The activity alert, therefore, may be an actual notice provided by web server 330 to offer server 320 or may be an effect of every web page request made by a user of the web server 330 upon which, for example, a tracking pixel is also embedded. Furthermore, in response to a tracking pixel served by an offer server, additional content may be loaded simultaneously, as described above, in order to generate an overlay or space for an offer in the web page or mobile application.

In response to the activity alert, the user is identified at 420. This identification is unique to a user so that the user may be distinguished from any number of other users. This may take place using the IP address, MAC address, a database of prior user activity, or other uniquely-identifiable information associated with the user.

The user activity is then monitored at 430. This process may involve the use of tracking pixels or data sharing between the web server 330 and the offer server 320. The user activity associated with the web server 330 (or web server 340 or both) serviced by the offer server 320 is monitored in real-time by the user identification and monitoring system 324. Data associated with those user activities may be stored so that analytics of a user's activities may be generated, either periodically or in real-time as the user browses one or more websites or operates various mobile applications.

Through this monitoring, “intent indicia” may be generated by a user in response to the data. Intent indicia are data suggesting that a particular user intends to or desires to carry out an action using a website or a mobile application. Intent indicia could indicate that a user wishes to obtain information pertaining to a web search term. For example, a user searching for the phrase “striped cat” on an informational website, may be seeking information pertaining to a tiger. In this scenario, the user's intent is to obtain information about a “striped cat” which may generate intent indicia suggesting that a tiger is the desired search term.

In response to intent indicia, the offer server may provide an offer, as described above, such as web page overlay providing additional information about tigers or including links or other information related to tigers. In this example, it is likely that the user's intent was to obtain information pertaining to a tiger and in response the offer server provides the offer of information pertaining to a tiger.

A subset of intent indicia is “purchase intent indicia.” Purchase intent indicia are data suggesting that a particular user intends to or desires to purchase a product or service or a class of product or services. Purchase intent indicia may be overt, such as a user adding a particular item to an online purchase “wishlist” or to a shopping cart. The purchase intent indicia may be a database entry identifying a product or service by name, SKU or ISBN or other similar product identification for which a user has indicated interest.

Alternatively, the purchase intent indicia may be generated in response to current user activity and a database of previous user activity. For example, as a user views certain sites or certain products, the system can determine whether or not a particular product or service currently being viewed has been the subject of viewing, research or other activity related to the product by the user. A purchase intent indicia may then be generated in real-time as a result of ongoing activity by a user. For further example, a user may previously have viewed a web page associated with a product. A user may return to the web page associated with the product. Upon a third return, the system may determine that the user has visited the same web page associated with the product three times and, as a result, generate a purchase intent indicia for this user with regard to the associated product and respond accordingly.

The purchase intent indicia may be generated as a result of one or more of: repeated viewing of a web page associated with a product or service, viewing of a series of web pages associated with a class of products or services, past activity indicating that a user is more likely to purchase if certain conditions (e.g. free shipping, tax paid by retailer) are met, adding a product to an online shopping cart, calculating the shipping costs associated with a product, searching for a product or service in a search engine, searching multiple retailer websites for a product or service, comparing multiple similar products or other similar indications of an intent or desire to purchase a product or service.

Purchase intent indicia may also be generated by a user sharing the product or a related link on a social network such as Twitter®, Facebook® and other similar services. Activity on third party websites, such as reviewers or other users, featuring the product or products similar to the product may also generate purchase intent indicia. Use of a store locator on a website may result in generation of purchase intent indicia. Alternatively, a history of regularly purchasing a product or series of products, for example, vitamins every three months, may results in the generation of purchase intent indicia.

Next, a determination whether intent indicia for the user exists is made at 435. This intent indicia may be purchase intent indicia. If no intent indicia exist, then the system may await receipt of the next activity alert at 410. If intent indicia is generated, then a determination is made whether a related action, such as a purchase, was completed at 445. This process may involve communication between the web server 330 and the offer server 320 in order to share data regarding completed activity or purchases. Alternatively, a tracking pixel served by the offer server 320 may be embedded in each web page associated with a product and a purchase process, including the final order confirmation web page. For example, adding a product to a shopping cart and later viewing the order confirmation page may cause the offer server 320 to mark an associated purchase intent indicia as completed, thereby eliminating it from consideration for future offers.

If the action, such as a purchase, is completed at 445, then the system may await further activity alerts at 410. If the action is not completed at 445, then the intent indicia generated by the user's activity is stored in association with the user identified by the user identification and monitoring system 324. If the activity is not completed, then the intent indicia are stored at 450 in a database associated with the user identification and monitoring system 324.

The user identification and monitoring system 324 continues to react to activity associated with the user, either on the same web site or any other web site serviced by the offer server. In this process, additional activity alert may be received at 460. This additional activity alert may be received on a subsequent visit to a web site serviced by the offer server 320 or may be additional activity or on-going activity during one visit to a web site. As a user interacts with a site, the interaction may generate additional activity alerts that are received at 460.

It should be noted that this interaction may be with any web server (e.g., web servers 330 and 340 shown as examples in FIG. 3) that is serviced by the offer server 320. The user activity monitoring is cross-web-server such that aggregate data from user activity associated with a plurality of web servers may be generated and stored, so long as the web servers are serviced by offer server 320.

In response to the additional activity alert received at 460, the intent indicia storage is accessed at 470 in order to determine whether or not a particular user has associated intent indicia. These intent indicia may be for the product or service that is the subject of the activity alert, may be for any other product or service offered by the web site from which the activity alert is received or may be related to a prior web search or other data request at 460. If there is no prior intent indicia at 475, particularly intent indicia related to the product, service or information that is the subject of the activity alert at 460, then the monitoring of user activity continues.

If there is prior intent indicia at 475, then an offer may be provided at 480. This offer may be related to the product, service or information that is the subject of the activity alert at 460. Alternatively, the offer may be unrelated to any current activity by a user. For example, the user's return to a site associated with a product for a threshold number of times, such as for a third time, may prompt an offer of free shipping or payment of tax should the user complete any purchase. Alternatively, a user's threshold number of visits, such as a third visit, to a site, regardless of the particular product being viewed, may prompt the offer server 320 to provide an offer of free shipping on the next purchase. Similarly, the offer server 320 may provide a series of escalating offers, as described in co-pending U.S. non-provisional patent application No. 13/176,659 entitled “Dynamic Frequency Capping with Escalating Offers.”

The offer may be provided in response to a prompt based upon rules determined by the operator of the web server 330. These rules may be, for example, input via an application programming interface (API) made available to the operator of the web server 330 or through the use of a graphical user interface or front end to the offer server 320. The operator of the web server 330 may change the rules as needed and set all parameters related to the rules.

For example, the offer may be prompted by repeated visits to a site, near-purchases (such as placing the product in a shopping cart or wish list, but not completing the purchase) or repeated near-purchases, a threshold value amount in a shopping cart, a threshold length of time viewing a site or web page associated with a product, a cumulative threshold over multiple visits to a site viewing the site or a web page associated with a product, a series of visits to multiple sites viewing web pages associated with competing products and similar rules. Offers may be made in such a way that they are designed to expire after a predetermined number of offers are made or after a predetermined number of offers are made or accepted by all users or specific users. Virtually any type of rule based upon any available data may be created by operators of the web server 330 with regard to the making of offers.

These rules may result in offers of discounts, free shipping, coverage for tax costs by the retailer, offers of additional products, buy one get one free offers and similar offers intended to encourage a user to complete the purchase of the product for which purchase intent indicia has been generated. In some cases, purchase intent indicia may be for a specific product or service or may simply be for a particular website. For example, the user may repeatedly visit a product web page or may visit a general retailer's website, but not complete any purchases. In order to encourage a completed purchase, the retailer may provide specific discounts on the product that is the subject of the product web page or may, alternatively, provide a general discount or free shipping in order to encourage any purchase, regardless of product.

If the offer is accepted and a purchase is completed, then the purchase intent indicia associated with the product or service may be removed from the database and credit for the offer may be given at 490. This credit may involve compensation to the offer server 320 for providing the offer that resulted in a completed sale. The compensation may be pre-negotiated by the web server 330 operator and the offer server 320 operator. If the offer is not accepted at 485, then the purchase intent indicia associated with the product or service is not removed from the database and the process ends. Though, subsequent user activity associated with the web server 330 may result in a new activity alert at 410 or 460.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A method for offer generation based upon website activity comprising:
identifying a user in response to interaction by the user with a first website accessible to an offer server;
monitoring the activity of the user on the first website;
determining that the activity generated intent indicia indicating that the user intended to carry out an action on the first website;
storing the intent indicia in a database;
accessing the database in order to obtain the intent indicia in response to further interaction by the user with a second website serviced by the offer server; and
providing an offer to the user in response to the interaction with the second website and the intent indicia.

2. The method of claim 1 wherein the first website is the second website.

3. The method of claim 1 wherein the intent indicia is a request for information and further wherein the offer is additional information related to the request.

4. The method of claim 1 wherein the intent indicia is purchase intent indicia indicating an intent to purchase a product and further wherein the offer is related to the product.

5. The method of claim 4 wherein the product is a service.

6. The method of claim 4 wherein the purchase intent indicia is a selected one of the following:
more than one interaction with a product web page associated with the product;
time exceeding a predetermined threshold viewing the web page associated with the product;
completing at least one of the following steps in the process of purchasing the product: adding the product to an online shopping cart;
calculating shipping costs for the product;
entering payment information for the product;
more than one interaction with a web page associated with a company that provides the product;
viewing a product web page more than a predetermined threshold number of times;
a determination that a number of products in an online shopping cart exceeds a predetermined threshold value;
sharing the product on a social network;
review of websites featuring products similar to the product;
a history of regularly purchasing a selected one of the product and a similar product; and
using a store locator feature available on the first website.

7. The method of claim 4 wherein the offer is a selected one of the following:
free shipping for the product;
a discounted price for the product;
an additional unit of the product for the same price;
a reminder to purchase the product;
a reminder that the user previously considered purchasing the product;
a suggestion to purchase a related product;
a suggestion to purchase a similar product;
a link to a promoted product available to only a select few purchasers; and
a link to a third website.

8. The method of claim 4 wherein the first website is a website featuring the product and the second website does not feature the product.

9. An apparatus for offer generation based upon website activity comprising a storage medium storing software which when executed by a processor will cause the processor to:
identify a user in response to interaction by the user with a first website accessible to an offer server;
monitor the activity of the user on the first website;
determine that the activity generated intent indicia indicating that the user intended to carry out an action on the first website;
store the intent indicia in a database;
access the database in order to obtain the intent indicia in response to further interaction by the user with a second website serviced by the offer server; and
provide an offer to the user in response to the interaction with the second website and the intent indicia.

10. The apparatus of claim 7 wherein the first website is the second website.

11. The apparatus of claim 7 wherein the intent indicia is a request for information and further wherein the offer is additional information related to the request.

12. The apparatus of claim 7 wherein the intent indicia is purchase intent indicia indicating an intent to purchase a product and further wherein the offer is related to the product.

13. The apparatus of claim 12 wherein the product is a service.

14. The apparatus of claim 12 wherein the purchase intent indicia is a selected one of the following:
more than one interaction with a product web page associated with the product;
time exceeding a predetermined threshold viewing the web page associated with the product;
completing at least one of the following steps in the process of purchasing the product: adding the product to an online shopping cart;
calculating shipping costs for the product;
entering payment information for the product;
more than one interaction with a web page associated with a company that provides the product;
viewing a product web page more than a predetermined threshold number of times;
a determination that a number of products in an online shopping cart exceeds a predetermined threshold value;
sharing the product on a social network;
review of websites featuring products similar to the product;
a history of regularly purchasing a selected one of the product and a similar product; and
using a store locator feature available on the first website.

15. The apparatus of claim 12 wherein the offer is a selected one of the following:
free shipping for the product;
a discounted price for the product;
an additional unit of the product for the same price;
a reminder to purchase the product;
a reminder that the user previously considered purchasing the product;
a suggestion to purchase a related product;
a suggestion to purchase a similar product;
a link to a promoted product available to only a select few purchasers; and
a link to a third website.

16. The apparatus of claim 12 wherein the first website is a website featuring the product and the second website does not feature the product.

17. The apparatus of claim 7 further comprising:
a processor;
a memory; and
wherein the processor and the memory comprise circuits and software form performing the instructions on the storage medium.
